(19) United States
(12) Patent Application Publication
(10) Pub. No.: US 2024/0219194 A1
(43) Pub. Date: Jul. 4, 2024

(54) VEHICLE AND CONTROL METHOD OF DISPLAYING DRIVER ASSISTANCE INFORMATION

(71) Applicants: Hyundai Motor Company, Seoul (KR); Kia Corporation, Seoul (KR)

(72) Inventors: Jaeseok Park, Yongin (KR); Moses Jueng, Seoul (KR); Jinyoung Park, Gwangmyeong (KR)

(21) Appl. No.: 18/397,587

(22) Filed: Dec. 27, 2023

(30) Foreign Application Priority Data
Dec. 29, 2022 (KR) 10-2022-0188865

(51) Int. Cl. G01C 21/36; B60K 35/23

(52) U.S. Cl. CPC G01C 21/367; B60K 35/23; G01C 21/3664; B60K 2360/1442; B60K 2360/166

(57) ABSTRACT

A vehicle and a control method are configured to display advanced driver assistance system (ADAS) information and navigation information on a display screen. The vehicle may include: a display configured to display, on the display screen, at least one of a first display area on which the navigation information is displayed or a second display area disposed on the first display area and on which the ADAS information and route guidance information are displayed; and a controller configured to receive a touch operation of the display screen or surrounding information of the vehicle as an input, control the display based on an input value of the input, so that only the first display area is displayed on the display screen, both the first display area and the second display area are displayed on the display screen, or a scale of the second display area is adjusted.

### CROSS-REFERENCE TO RELATED APPLICATION

This application claims under 35 U.S.C. § 119(a) the benefit of Korean Patent Application No. 10-2022-0188865, filed on Dec. 29, 2022 in the Korean Intellectual Property Office, the entire contents of which are incorporated herein by reference.

### BACKGROUND

### (a) Technical Field

The present disclosure is related to a vehicle and a control method, more particularly, to the vehicle and the control method configured to display advanced driver assistance system (ADAS) information and navigation information on a single display screen.

### (b) Description of the Related Art

An advanced driver assistance system (ADAS) is a system for assisting a driver's safe and convenient driving. For example, ADAS is operated when traffic congestion occurs or a preceding vehicle suddenly slows down or stops.

By using information collected by various sensors such as a camera, a radar, a light detection and ranging (Lidar), an ultrasonic sensor, and the like, ADAS provides a variety of functions, such as autonomous emergency braking (AEB) to slow down or stop itself without a driver applying brakes in the event of a collision, lane departure warning (LDW) to warn a driver when leaving a lane, lane keeping assist (LKA) to stay in a lane by adjusting a driving direction when a vehicle is leaving the lane, smart cruise control (SCC) to maintain a distance to a preceding vehicle while driving at a predetermined speed, active blind-spot detection (ABSD) to assist to detect a risk of blind spot collision and change lanes to a safer lane, around-view monitoring (AVM) for a visual view of vehicle's surroundings, and the like.

Conventionally, various ADAS information related to vehicle surroundings is displayed on a cluster or a head-up display in front of a driver.

In addition, navigation information including real-time travel path, traffic information, maps, and the like, is displayed on a screen disposed in an audio, video, navigation, telematics (AVNT) area.

As such, conventionally, ADAS information and navigation information are displayed in different areas, requiring improvements for more efficient use of a display and safe driving.

### SUMMARY

An embodiment of the disclosure provides a vehicle and a control method of a vehicle display that may effectively display advanced driver assistance system (ADAS) information and navigation information on a single display screen.

Additional embodiments of the disclosure will be set forth in part in the description which follows and, in part, will be obvious from the description, or may be learned by practice of the disclosure.

According to an embodiment of the disclosure, a vehicle may include: a display configured to display, on a display screen, at least one of a first display area on which navigation information is displayed or a second display area disposed on the first display area and on which advanced driver assistance system (ADAS) information and route guidance information are displayed; and a controller configured to: receive a touch operation of the display screen or surrounding information of the vehicle as an input, and control the display based on an input value of the input, so that only the first display area is displayed on the display screen, both the first display area and the second display area are displayed on the display screen, or a scale of the second display area is adjusted.

The controller may be configured to control the second display area to disappear, in response to tapping the second display area by a user in a state where both the first display area and the second display area are displayed.

In response to tapping a desired location by a user on a map displayed on the first display area, the controller may be configured to control scrolling the map to the location, and in response to deviating from a current driving route according to scrolling of the map, control the second display area to disappear.

The ADAS information may include driving information of the vehicle for driver assistance, information about a distance to another vehicle, information about surrounding traffic volume, information about a location of entering a highway or a tollgate or transferring to another highway, information about a location of a left or right turn, a U-turn, or a lane-changing location, information about weather and road environment, information about a driving time, and information about a speed of a nearby vehicle.

The surrounding information of the vehicle may include information about surrounding traffic volume, and the controller may be configured to control only the first display area to be displayed on the display screen in response to the surrounding traffic volume being less than a predetermined value, and control both the first display area and the second display area to be displayed on the display screen in response to the surrounding traffic volume exceeding the predetermined value.

The surrounding information of the vehicle may include information about a location of entering a highway or a tollgate or transferring to another highway, and the controller may be configured to control both the first display area and the second display area to be displayed on the display screen in response to the vehicle reaching the location.

The surrounding information of the vehicle may include information about a location of a left or right turn, a U-turn, or a lane-changing location, and the controller may be configured to control both the first display area and the second display area to be displayed on the display screen in response to the vehicle reaching the location.

The surrounding information of the vehicle may include information about weather and road environment, and the controller may be configured to determine a driving difficulty level based on the information about weather and road environment, in response to the driving difficulty level exceeding a predetermined value and only the first display area being displayed on the display screen, control the second display area to be additionally displayed on the display screen, and in response to the driving difficulty level exceeding the predetermined value and both the first display area and the second display area being displayed on the display screen, increase the scale of the second display area according to a predetermined value.

The surrounding information of the vehicle may include information about a driving time of the vehicle, and the controller may be configured to: in response to the driving time exceeding a predetermined value and only the first display area being displayed on the display screen, control the second display area to be additionally displayed on the display screen, and in response to the driving time exceeding the predetermined value and both the first display area and the second display area being displayed on the display screen, increase the scale of the second display area according to a predetermined value.

The surrounding information of the vehicle may include information about a speed of a nearby vehicle, and the controller may be configured to: in response to the speed of the nearby vehicle exceeding a predetermined value, control only the first display area to be displayed on the display screen, and in response to the speed of the nearby vehicle being less than the predetermined value, control both the first display area and the second display area to be displayed on the display screen.

The surrounding information of the vehicle may include information about a speed of a vehicle approaching from behind, and the controller may be configured to control the second display area to be additionally displayed on the display screen, in response to the speed exceeding a predetermined value and only the first display area being displayed on the display screen.

In response to receiving a plurality of pieces of surrounding information of the vehicle, the controller may be configured to control the display based on an input value with a highest priority according to predetermined priorities.

The display may be mounted on at least one of an audio, video, navigation, telematics (AVNT) area, a cluster, and a head-up display (HUD) area of the vehicle.

According to another embodiment of the disclosure, a control method of a vehicle display may include: displaying, on a display screen of a display, both a first display area on which navigation information is displayed and a second display area disposed on the first display area and on which ADAS information and route guidance information are displayed; receiving a touch operation of the display screen or surrounding information of a vehicle as an input; and controlling the display based on an input value of the input, so that only the first display area is displayed on the display screen, both the first display area and the second display area are displayed on the display screen, or a scale of the second display area is adjusted.

The controlling may include controlling only the first display area to be displayed on the display screen in response to surrounding traffic volume being less than a predetermined value, and controlling both the first display area and the second display area to be displayed on the display screen in response to the surrounding traffic volume exceeding the predetermined value.

The controlling may include controlling both the first display area and the second display area to be displayed on the display screen in response to the vehicle reaching a location of entering a highway or a tollgate or transferring to another highway.

The controlling may include controlling both the first display area and the second display area to be displayed on the display screen in response to the vehicle reaching a location of a left or right turn, a U-turn, or a lane-changing location.

The controlling may include determining a driving difficulty level based on information about weather and road environment, in response to the driving difficulty level exceeding a predetermined value and only the first display area being displayed on the display screen, controlling the second display area to be additionally displayed on the display screen, and in response to the driving difficulty level exceeding the predetermined value and both the first display area and the second display area being displayed on the display screen, increasing the scale of the second display area according to a predetermined value.

The controlling may include, in response to a driving time of the vehicle exceeding a predetermined value and only the first display area being displayed on the display screen, controlling the second display area to be additionally displayed on the display screen, and in response to the driving time exceeding the predetermined value and both the first display area and the second display area being displayed on the display screen, increasing the scale of the second display area according to a predetermined value.

The controlling may include, in response to a speed of a nearby vehicle exceeding a predetermined value, controlling only the first display area to be displayed on the display screen, and in response to the speed of the nearby vehicle being less than the predetermined value, controlling both the first display area and the second display area to be displayed on the display screen.

The controlling may include controlling the second display area to be additionally displayed on the display screen, in response to a speed of a vehicle approaching from behind exceeding a predetermined value and only the first display area being displayed on the display screen.

In response to receiving a plurality of pieces of surrounding information of the vehicle, the controlling may include controlling the display based on an input value with a highest priority according to predetermined priorities.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a block diagram illustrating constituent components of a vehicle according to an embodiment;

FIG. 2 illustrates a display according to an embodiment;

FIG. 3 illustrates a first display area and a second display area of the display of FIG. 2;

FIG. 4 illustrates an example of reducing a scale of the second display area shown in FIG. 3; and

FIG. 5 is a flowchart illustrating a control method of a vehicle display according to an embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Like reference numerals throughout the specification denote like elements. Also, this specification does not describe all the elements according to embodiments of the disclosure, and descriptions well-known in the art to which the disclosure pertains or overlapped portions are omitted.

It will be understood that when an element is referred to as being “connected” to another element, it can be directly or indirectly connected to the other element, wherein the indirect connection includes “connection” via a wireless communication network.

It is to be understood that the singular forms are intended to include the plural forms as well, unless the context clearly dictates otherwise.

The terms such as “˜part”, “˜device”, “˜block”, “˜member”, “˜module”, and the like may refer to a unit for processing at least one function or act. For example, the terms may refer to at least process processed by at least one hardware, such as field-programmable gate array (FPGA)/application specific integrated circuit (ASIC), software stored in memories or processors.

Reference numerals used for method steps are just used for convenience of explanation, but not to limit an order of the steps. Thus, unless the context clearly dictates otherwise, the written order may be practiced otherwise.

Hereinafter, embodiments of the disclosure will be described in detail with reference to the accompanying drawings.

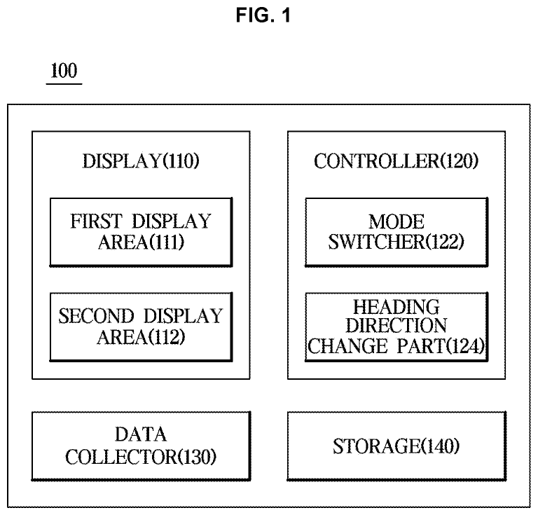

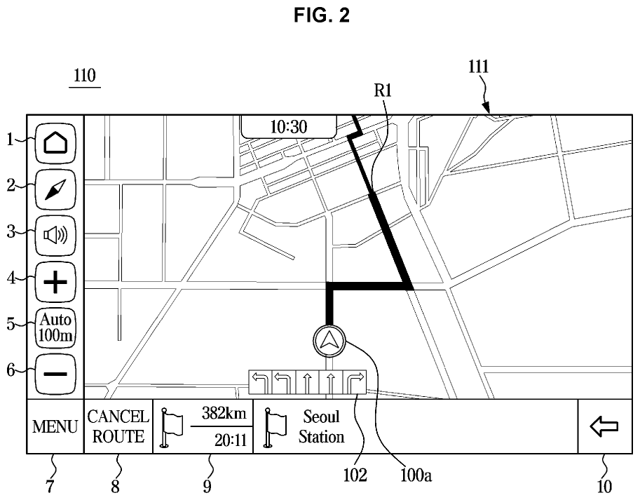

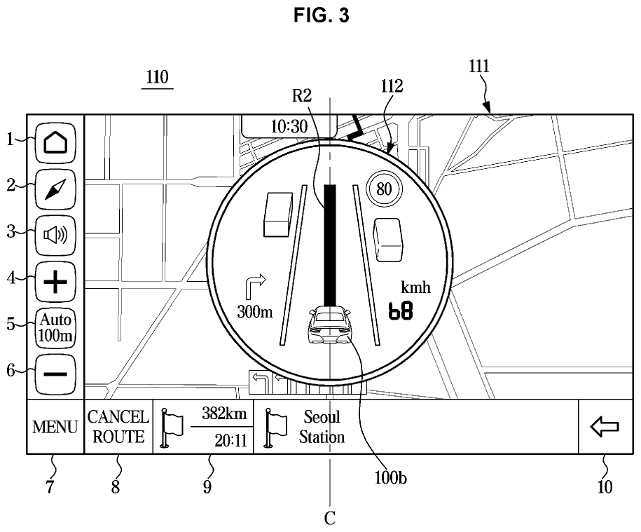

FIG. 1 is a block diagram illustrating constituent components of a vehicle according to an embodiment. FIG. 2 illustrates a display according to an embodiment. FIG. 3 illustrates a first display area and a second display area of the display of FIG. 2.

Referring to FIG. 1 to FIG. 3, a vehicle 100 according to an embodiment includes a display 110, a controller 120, a data collector 130 and a storage 140. Here, the display 110 displays, on a display screen, at least one of a first display area 111 on which navigation information is displayed or a second display area 112 disposed on the first display area 111 and on which advanced driver assistance system (ADAS) information and route guidance information are displayed. The controller 120 receives a touch operation of the display screen or surrounding information of the vehicle 100 as an input, and controls the display 110 based on an input value of the input, so that only the first display area 111 is displayed on the display screen, both the first display area 111 and the second display area 112 are displayed on the display screen, or a scale of the second display area 112 is adjusted.

Here, the navigation information may include real-time map information according to a driving route of the vehicle 100, and the like.

The ADAS information may include driving information of the vehicle for driver assistance, information about a distance to another vehicle, information about surrounding traffic volume, information about a location of entering a highway or a tollgate or transferring to another highway, information about a location of a left or right turn, a U-turn, or a lane-changing location, information about weather and road environment, information about a driving time, and/or information about a speed of a nearby vehicle.

The second display area 112 may be disposed in a center line C of the first display area 111 so that a position of the vehicle 100 displayed in graphic form on the second display area 112 is aligned with a driving route displayed on the first display area 111.

In a state where both the first display area 111 and the second display area 112 are displayed on the display screen of the display 110, when a user taps (touches) the second display area 112, the controller 120 may control the second display area 112 to disappear.

Also, when the user taps a desired location on a map displayed on the first display area 111, the controller 120 may control scrolling (movement) the map to the corresponding location, and when deviating from a current driving route according to scrolling of the map, control the second display area 112 to disappear.

In addition, the controller 120 may include a mode switcher 122 to switch a mode between a heading-up mode where a map is always displayed so that a driving direction of the vehicle 100 is toward a top of the display screen, and a northbound fixation mode where the map is always displayed so that north is toward a top of the display screen regardless of the driving direction of the vehicle 100, when consecutively tapping the first display area 111 or the second display area 112.

Furthermore, the controller 120 may include a heading direction change part 124 to rotate and display a heading direction of the vehicle 100 when moving to a desired direction in a state where the first display area 111 or the second display area 112 is touched.

The above-described surrounding information of the vehicle 100 includes information about surrounding traffic volume. When the surrounding traffic volume is less than a predetermined value, the controller 120 may control only the first display area 111 to be displayed on the display screen, and when the surrounding traffic volume exceeds the predetermined value, control both the first display area 111 and the second display area 112 to be displayed on the display screen.

The surrounding information of the vehicle 100 also includes information about a location of entering a highway or a tollgate or transferring to another highway. When the vehicle 100 reaches the corresponding location, the controller 120 may control both the first display area 111 and the second display area 112 to be displayed on the display screen.

The surrounding information of the vehicle 100 also includes at least one of information about a location of a left or right turn, a U-turn, and a lane-changing location. When the vehicle 100 reaches the corresponding location, the controller 120 may control both the first display area 111 and the second display area 112 to be displayed on the display screen.

The surrounding information of the vehicle 100 also includes information about weather and road environment, and the controller 120 may determine a driving difficulty level based on the information about weather and road environment. When the driving difficulty level exceeds a predetermined value and only the first display area 111 is displayed on the display screen, the controller 120 may control the ADAS information to be additionally displayed on the display screen. When the driving difficulty level exceeds the predetermined value and both the first display area 111 and the second display area 112 are displayed on the display screen, the controller 120 may increase a scale of the second display area 112 on which the ADAS information is displayed according to a predetermined value.

The surrounding information of the vehicle 100 also includes information about a driving time of the vehicle. When the driving time exceeds a predetermined value and only the first display area 111 is displayed on the display screen, the controller 120 may control the ADAS information to be additionally displayed on the display screen, and when the driving time exceeds the predetermined value and both the first display area 111 and the second display area 112 are displayed on the display screen, increase the scale of the second display area 112 on which the ADAS information is displayed according to a predetermined value.

The surrounding information of the vehicle 100 also includes information about a speed of a nearby vehicle. When the speed of the nearby vehicle exceeds a predetermined value, the controller 120 may control only the first display area 111 to be displayed on the display screen, and when the speed of the nearby vehicle is less than the predetermined value, control both the first display area 111 and the second display area 112 to be displayed on the display screen.

The surrounding information of the vehicle 100 also includes information about a speed of a vehicle approaching from behind. When the speed of the vehicle approaching from behind exceeds a predetermined value, the controller 120 may control both the first display area 111 and the second display area 112 to be displayed on the display screen.

In addition, when a plurality of pieces of surrounding information of the vehicle 100 is received, the controller 120 may control the display 110 based on an input value with a highest priority according to predetermined priorities.

The above-described controller 120 may control not only the described constituent components, but non-illustrated constituent components of the vehicle 100 and means related thereto. The controller 120 may also include various processors. For example, the controller 120 may include a control unit such as an electronic control unit (ECU), micro controller unit (MCU), and the like.

The data collector 130 may collect various information inside and outside the vehicle 100, and the collected information may be provided to the controller 120 and used to control the display 110. For example, the data collector 130 may include a variety of sensors such as a camera, laser imaging, detection, and ranging (Lidar), radar, acceleration sensor, speed sensor, global positioning system (GPS) sensor, angular speed sensor, and the like. Through the above sensors, the data collector 130 may collect various driving data and surrounding information such as a vehicle speed, steering angle, yaw rate, distance to a vehicle in front, lane-changing signal, road type, driving time period, acceleration, sudden acceleration, sudden deceleration, sudden stop, sudden lane change, and the like.

Although not illustrated, the data collector 130 may transmit and receive various information by performing communication with external devices such as a weather information providing server, traffic control server, vehicle management server providing a connected car service, and the like.

The storage 140 may store various programs, instructions, applications, and the like, for controlling the vehicle 100. For example, the storage 140 may include a volatile memory such as a random access memory (RAM), a non-volatile memory such as a cache, a flash memory, a read only memory (ROM), a programmable read only memory (PROM), an erasable programmable read only memory (EPROM), an electrically erasable programmable read only memory (EEPROM), etc., or a recording media such as a hard disk drive (HDD), or a compact disc read only memory (CD-ROM), without being limited thereto.

The storage 140 may store various information collected by the data collector 130 of the vehicle 100, image data, analysis data, various information related to a vehicle and a driver, information related to a time, a location, various setting values, driving routes, and maps, traffic information, and the like.

Hereinafter, each constituent component of the vehicle 100 according to an embodiment is described in detail.

The display 110 may be mounted on at least one of an audio, video, navigation, telematics (AVNT) area, a cluster, and a head-up display (HUD) area in front of a driver inside the vehicle 100, without being limited thereto. The display 110 may be disposed in various positions, as required.

The display 110 may intuitively deliver various information about an inside and outside of the vehicle 100 to the driver.

The display 110 may be installed on a dashboard to be upright or to be embedded within the dashboard.

The display 110 may include a light emitting diode (LED), an organic LED (OLED), or a liquid crystal display (LCD). The display 110 may include a touch screen to receive a user's touch operation.

The display 110 may display navigation information, route guidance information and ADAS information together.

The navigation information may include real-time travel path, traffic information, map information, and the like.

The ADAS information may include driving information of the vehicle for driver assistance, information about a distance to another vehicle, information about surrounding traffic volume, information about a location of entering a highway or a tollgate or transferring to another highway, information about a location of a left or right turn, a U-turn, or a lane-changing location, information about weather and road environment, information about a driving time, and information about a speed of a nearby vehicle.

The display 110 may display, on a display screen, both the first display area 111 on which navigation information is displayed and the second display area 112 disposed on the first display area 111 and on which ADAS information and route guidance information are displayed.

The first display area 111, as a main screen, is basically maintained to display the navigation information. The first display area 111 may also display an image of at least one function selected by a user from various functions such as an audio, video, navigation, broadcasting, radio, content playback, online search, and the like.

The second display area 112 displays the route guidance information and the various ADAS information for driver assistance. The ADAS information displayed on the second display area 112 may be displayed in a manner that overlaps with information of the first display area 111. In an embodiment of the disclosure, the second display area 112 is displayed in a circular form to distinguish information displayed on the second display area 112 from information displayed on the first display area 111.

Referring to FIG. 2, map information for route guidance including a vehicle mark 100a, lane information 102, a driving route R1, and the like, is displayed on the first display area 111.

For example, by tapping the vehicle mark 100a, the second display area 112 may be activated by the controller 120 and displayed on the first display area 111. An animation effect such as gradually increasing a size of the second display area 112, and the like, may be used to display that the second display area 112 has been activated.

On a left portion of the first display area 111, menus for selecting a function such as a home screen 1, change of map display method 2, volume control 3, map enlargement 4, automatic or manual map scale setting 5, map reduction 6, and the like, may be displayed.

In a lower portion of the first display area 111, menus for selecting a function such as a simple menu for use during route guidance 7, cancel route 8, hide or display detailed guidance 10, and the like. In addition to the above, information about a distance to a destination and estimated arrival time 9, information about a point to change direction this time or next time, and the like, may be displayed on the first display area 111.

Referring to FIG. 3, the second display area 112 may be disposed on a portion of the first display area 111 in a circular form, and be disposed in a center line C of the first display area 111 so that a position of the vehicle 100b displayed on the second display area 112 is aligned with a driving route displayed on the first display area 111.

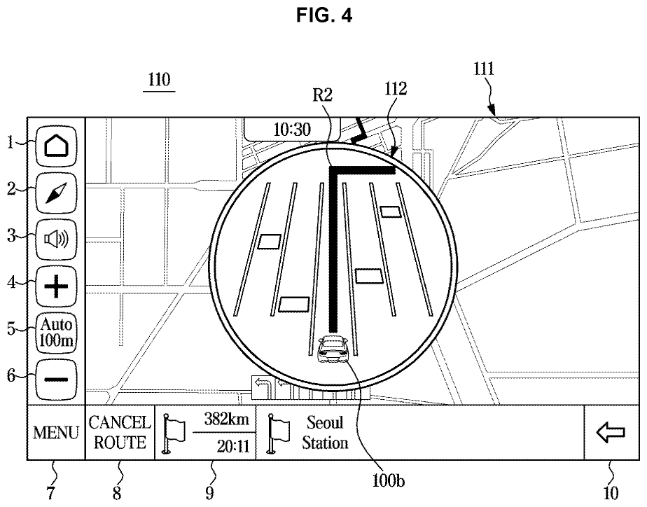

FIG. 4 illustrates an example of reducing a scale of the second display area shown in FIG. 3.

Referring to FIG. 4, a screen scale (also referred to as a map scale) of the second display area 112 is changeable. For example, a screen scale may be reduced to show five left and right lanes around the vehicle. In this instance, only the screen scale of the second display area 112 may be changed without changing a diameter of a circle of the second display area 112, which is displayed in a circular form, thereby displaying more surrounding information around the vehicle 100.

In a state where both the first display area 111 and the second display area 112 are displayed on a display screen of the display 110, when a user taps the second display area 112, the controller 120 may control the secondo display area 112 to disappear. For example, when the user taps the second display area 112 once, the second display area 112 may disappear. The number of taps may be changed in other examples.

Also, when a user taps a desired location on a map displayed on the first display area 111, the controller 120 may control scrolling (movement) the map to the desired location, and when deviating from a current driving route according to scrolling of the map, control the second display area 112 to disappear. For example, the user may zoom in or out of the map by pinching out or in the display screen with two fingers, and the map is scrolled to a desired location by tapping the desired location on the map screen. In this instance, when deviating from a current driving route, the second display area 112 may disappear.

In addition, when consecutively tapping the first display area 111 or the second display area 112, a mode may be switched by the mode switcher 122 between a heading-up mode where a map is always displayed so that a driving direction of the vehicle 100 is toward a top of the display screen, and a northbound fixation mode where the map is always displayed so that north is toward a top of the display screen regardless of the driving direction of the vehicle 100. In this instance, the number of taps may be changed in other examples.

Furthermore, when swiping to a desired direction in a state where the first display area 111 or the second display area 112 is touched, a heading direction of the vehicle 100 may be rotated and displayed by the heading direction change part 124. For example, by tapping and moving both the first display area 111 and the second display area 112 with two fingers, the heading direction of the vehicle 100 may be rotated on the display screen.

Meanwhile, when surrounding traffic volume is less than a predetermined value, the controller 120 may control only the navigation information of the first display area 111 to be displayed on the display screen of the display 110, and when the surrounding traffic volume exceeds the predetermined value, control both the first display area 111 and the second display area 112 to be displayed on the display screen of the display 110.

That is, as shown in FIG. 2, when traffic volume is less than the predetermined value, only the navigation information of the first display area 111 may be displayed on the display screen of the display 110. In this instance, a route guidance color of detailed guidance is changeable depending on the traffic volume, and when the traffic volume is less than the predetermined value, the route guidance may be displayed in green.

As shown in FIG. 3, when the traffic volume exceeds the predetermined value, the second display area 112 may be displayed on the first display area 111, and navigation information and ADAS information related to surroundings of the vehicle may be displayed in the first display area 111 and the second display area 112, respectively. In this instance, for example, a route may be displayed up to 50 m in front in red, and a single left land and a single right lane around the vehicle 100 may be displayed, in consideration of surroundings when traffic is congested, that is, many vehicles existing within 100 m around the vehicle, relatively slow speeds of nearby vehicles, and surrounding information of the vehicle which is more important than the route itself.

When the vehicle 100 enters a highway or a tollgate TG at an interchange IC or a junction JC or transfers to another highway, a distance between a current location of the vehicle 100 and a point of entering the highway or tollgate or transferring to the other highway is critical, and thus the controller 120 may control both the first display area 111 and the second display area 112 to be displayed on the display screen of the display 110.

When the vehicle 100 reaches a location of a left or right turn, U-turn, or a lane-changing location, the controller 120 may control the second display area 112 to be displayed on the first display area 111, so that navigation information and ADAS information related to the left or right turn, U-turn, or the lane-changing location may be displayed on the first display area 111 and the second display area 112, respectively, which is because displaying both the navigation information and the ADAS information is advantageous due to significance of the amount of information around the vehicle 100 at the location of a left or right turn, U-turn, or the lane-changing location.

When a speed of a nearby vehicle is lower than a predetermined value due to an accident or a broken vehicle, the controller 120 may control the second display area 112 to be displayed on the first display area 111, so that navigation information and ADAS information related to surroundings of the vehicle 100 may be displayed on the first display area 111 and the second display area 112, respectively. When the speed of the nearby vehicle exceeds the predetermined value, the controller 120 may control only the navigation information of the first display area 111 to be displayed.

Also, when a speed of a vehicle approaching from behind exceeds a predetermined value, the controller 120 control the second display area 112 to be displayed on the first display area 111, so that both the first display area 111 and the second display area 112 may be displayed together on the display screen of the display 110.

As shown in FIG. 4, when traffic volume is neither small nor large, and falls within a set range, the controller 120 may control the second display area 112 to be displayed on the first display area 111 by reducing a scale of the second display area 112 by one level according to a set value. In this instance, for example, a route may be displayed up to 400 m in front in yellow, and five left land and right lanes around the vehicle 100 may be displayed.

As such, a scale of the second display area 112 may be adjusted as shown in FIG. 3 and FIG. 4.

For example, the controller 120 may determine a driving difficulty level based on information about weather and road environment. When the driving difficulty level exceeds a predetermined value and the second display area 112 is non-existent on the first display area 111 on the display screen of the display 110, the controller 120 may control the second display area 112 to be displayed, and when the second display area 112 is displayed on the first display area 111 together as shown in FIG. 4, increase the scale of the second display area 112 on which the ADAS information is displayed by one level as shown in FIG. 3.

In addition, based on information about weather and road environment such as a wind speed, temperature, road icing due to low temperatures, wet roads due to rain or snow, unpaved roads, and the like, the controller 120 may determine a driving difficulty level, and control the second display area 112 to be displayed on the first display area 111 according to the driving difficulty level, or when the second display area 112 is already displayed, increase the scale of the second display area 112 by one level.

Furthermore, when a driving time exceeds a predetermined value and the second display area 112 is non-existent on the first display area 111, the controller 120 may control the second display area 112 to be displayed on the first display area 111, and when both the first display area 111 and the second display area 112 are already displayed together, increase the scale of the second display area 112 by one level.

For example, when the driving time exceeds three hours, the controller 120 may control the second display area 112 to be displayed on the first display area 111 in the display 110 according to the driving time, and when the second display area 112 is already displayed, increase the scale of the second display area 112 by one level.

When a plurality of pieces of above-described surrounding information of the vehicle 100 is received, the controller 120 may control the display 110 based on an input value with a highest priority according to predetermined priorities. For example, the information about surrounding traffic volume may be set as the highest priority, and whether the vehicle reaches a location of entering a highway or a tollgate or transferring to another highway and the information about whether the vehicle reaches a location of a left or right turn, a U-turn, or a lane-changing location may be set as the second highest priority. The information about weather and road environment and the information about a driving time of vehicle may be set as relatively lower priorities than the other surrounding information. Accordingly, when a plurality of pieces of surrounding information of the vehicle 100 is received, the controller 120 may control the display 110 based on the input value with the highest priority among the predetermined priorities, thereby assisting a driver's safer and more convenient driving.

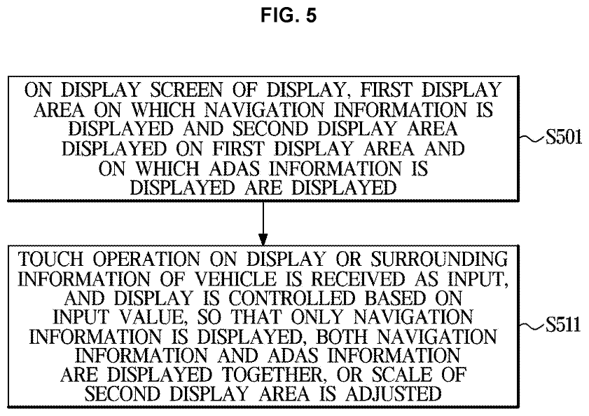

FIG. 5 is a flowchart illustrating a control method of a vehicle display according to an embodiment. Hereinafter, details of redundant descriptions thereof will be omitted.

On a display screen of the display 110, both the first display area 111 on which navigation information is displayed and the second display area 112 displayed on the first display area 111 and on which ADAS information is displayed are displayed (S501). In this instance, route guidance information may be additionally provided on the second display area 112 together with the ADAS information.

The ADAS information may include driving information of the vehicle for driver assistance, information about a distance to another vehicle, information about surrounding traffic volume, information about a location of entering a highway or a tollgate or transferring to another highway, information about a location of a left or right turn, a U-turn, or a lane-changing location, information about weather and road environment, information about a driving time, and information about a speed of a nearby vehicle.

Afterwards, a touch operation on the display 110 or surrounding information of the vehicle is received as an input, and the display 110 is controlled based on an input value of the input, so that only the navigation information is displayed, both the navigation information and the ADAS information are displayed together, or a scale of the second display area 112 is adjusted (S511).

In operation S511, only the first display area 111 may be displayed on the display screen, both the first display area 111 and the second display area 112 may be displayed on the display screen, or the scale of the second display area 112 may be adjusted. In this instance, the route guidance information may be additionally provided on the second display area 112 together with the ADAS information.

In operation S511, when a plurality of pieces of surrounding information of the vehicle is received, the display 110 may be controlled based on an input value with a highest priority according to predetermined priorities.

Also, in operation S511, when surrounding traffic volume is less than a predetermined value, only the first display area 111 may be displayed on the display 110, and when the surrounding traffic volume exceeds the predetermined value, both the first display area 111 and the second display area 112 may be displayed together on the display 110.

Also, in operation S511, when the vehicle reaches a location of entering a highway or a tollgate or transferring to another highway, both the first display area 111 and the second display area 112 may be displayed together on the display 110.

Also, in operation S511, when the vehicle reaches a location of a left or right turn, a U-turn, or a lane-changing location, both the first display area 111 and the second display area 112 may be displayed together on the display 110.

Also, in operation S511, by determining a driving difficulty level based on information about weather and road environment, when the driving difficulty level exceeds a predetermined value and only the first display area 111 is displayed on the display screen of the display 110, the second display area 112 may be additionally displayed on the first display area 111 on the display screen to display the ADAS information. When the driving difficulty level exceeds the predetermined value and both the first display area 111 and the second display area 112 are displayed on the display screen, a scale of the second display area 112 may be increased according to a predetermined value.

Also, in operation S511, when a driving time of the vehicle exceeds a predetermined value and only the first display area 111 is displayed on the display screen, the second display area 112 may be additionally displayed on the first display area 111 to display the ADAS information. When the driving time exceeds the predetermined value and both the first display area 111 and the second display area 112 are displayed on the display screen, the scale of the second display area 112 may be increased according to a predetermined value.

Also, in operation S511, when a speed of a nearby vehicle exceeds a predetermined value, only the first display area 111 may be displayed on the display screen, and when the speed of the nearby vehicle is less than the predetermined value, both the first display area 111 and the second display area 112 may be displayed on the display screen of the display 110 by additionally displaying the second display area 112 on the first display area 111.

Also, in operation S511, when a speed of a vehicle approaching from behind exceeds a predetermined value, both the first display area 111 and the second display area 112 may be displayed on the display screen of the display 110 by additionally displaying the second display area 112 on the first display area 111.

As is apparent from the above, according to the embodiments of the disclosure, the vehicle and the control method of a vehicle display can effectively display ADAS information and navigation information on a single display screen.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A vehicle, comprising:
a display configured to display, on a display screen, at least one of a first display area on which navigation information is displayed or a second display area disposed on the first display area and on which advanced driver assistance system (ADAS) information and route guidance information are displayed; and
a controller configured to:
receive a touch operation of the display screen or surrounding information of the vehicle as an input, and
control the display based on an input value of the input, so that only the first display area is displayed on the display screen, both the first display area and the second display area are displayed on the display screen, or a scale of the second display area is adjusted.

2. The vehicle of claim 1, wherein the controller is configured to control the second display area to disappear, in response to tapping the second display area by a user in a state where both the first display area and the second display area are displayed.

3. The vehicle of claim 1, wherein, in response to tapping a desired location by a user on a map displayed on the first display area, the controller is configured to control scrolling the map to the desired location, and in response to deviating from a current driving route according to scrolling of the map, control the second display area to disappear.

4. The vehicle of claim 1, wherein the ADAS information includes at least one of: driving information of the vehicle for driver assistance, information about a distance to another vehicle, information about surrounding traffic volume, information about a location of entering a highway or a tollgate or transferring to another highway, information about a location of a left or right turn, a U-turn, or a lane-changing location, information about weather and road environment, information about a driving time, or information about a speed of a nearby vehicle.

5. The vehicle of claim 1, wherein the surrounding information of the vehicle includes information about surrounding traffic volume, and
the controller is configured to control only the first display area to be displayed on the display screen in response to the surrounding traffic volume being less than a predetermined value, and control both the first display area and the second display area to be displayed on the display screen in response to the surrounding traffic volume exceeding the predetermined value.

6. The vehicle of claim 1, wherein the surrounding information of the vehicle includes information about a location of the vehicle entering a highway or a tollgate or transferring to another highway, and
the controller is configured to control both the first display area and the second display area to be displayed on the display screen in response to the vehicle reaching the location.

7. The vehicle of claim 1, wherein the surrounding information of the vehicle includes at least one of: information about a location of a left or right turn, a U-turn, or a lane-changing location, and
the controller is configured to control both the first display area and the second display area to be displayed on the display screen in response to the vehicle reaching the location.

8. The vehicle of claim 1, wherein the surrounding information of the vehicle includes information about weather and road environment, and
the controller is configured to determine a driving difficulty level based on the information about weather and road environment,
in response to the driving difficulty level exceeding a predetermined value and only the first display area being displayed on the display screen, control the second display area to be additionally displayed on the display screen, and
in response to the driving difficulty level exceeding the predetermined value and both the first display area and the second display area being displayed on the display screen, increase the scale of the second display area according to a predetermined value.

9. The vehicle of claim 1, wherein the surrounding information of the vehicle includes information about a driving time of the vehicle, and
the controller is configured to:
in response to the driving time exceeding a predetermined value and only the first display area being displayed on the display screen, control the second display area to be additionally displayed on the display screen, and
in response to the driving time exceeding the predetermined value and both the first display area and the second display area being displayed on the display screen, increase the scale of the second display area according to a predetermined value.

10. The vehicle of claim 1, wherein the surrounding information of the vehicle includes information about a speed of a nearby vehicle, and
the controller is configured to:
in response to the speed of the nearby vehicle exceeding a predetermined value, control only the first display area to be displayed on the display screen, and
in response to the speed of the nearby vehicle being less than the predetermined value, control both the first display area and the second display area to be displayed on the display screen.

11. The vehicle of claim 1, wherein the surrounding information of the vehicle includes information about a speed of a vehicle approaching from behind, and
the controller is configured to control the second display area to be additionally displayed on the display screen, in response to the speed exceeding a predetermined value and only the first display area being displayed on the display screen.

12. The vehicle of claim 1, wherein, in response to receiving a plurality of pieces of surrounding information of the vehicle, the controller is configured to control the display based on an input value with a highest priority according to predetermined priorities.

13. The vehicle of claim 1, wherein the display is mounted on at least one of an audio, video, navigation, telematics (AVNT) area, a cluster, and a head-up display (HUD) area of the vehicle.

14. A control method of a vehicle display, the control method comprising:
displaying, on a display screen of a display, both a first display area on which navigation information is displayed and a second display area disposed on the first display area and on which ADAS information and route guidance information are displayed;
receiving a touch operation of the display screen or surrounding information of a vehicle as an input; and
controlling, by a controller, the display based on an input value of the input, so that only the first display area is displayed on the display screen, both the first display area and the second display area are displayed on the display screen, or a scale of the second display area is adjusted.

15. The control method of claim 14, wherein the controlling comprises controlling only the first display area to be displayed on the display screen in response to surrounding traffic volume being less than a predetermined value, and controlling both the first display area and the second display area to be displayed on the display screen in response to the surrounding traffic volume exceeding the predetermined value.

16. The control method of claim 14, wherein the controlling comprises controlling both the first display area and the second display area to be displayed on the display screen in response to the vehicle reaching a location of entering a highway or a tollgate or transferring to another highway.

17. The control method of claim 14, wherein the controlling comprises controlling both the first display area and the second display area to be displayed on the display screen in response to the vehicle reaching a location of a left or right turn, a U-turn, or a lane-changing location.

18. The control method of claim 14, wherein the controlling comprises:
determining a driving difficulty level based on information about weather and road environment,
in response to the driving difficulty level exceeding a predetermined value and only the first display area being displayed on the display screen, controlling the second display area to be additionally displayed on the display screen, and
in response to the driving difficulty level exceeding the predetermined value and both the first display area and the second display area being displayed on the display screen, increasing the scale of the second display area according to a predetermined value.

19. The control method of claim 14, wherein the controlling comprises:
in response to a driving time of the vehicle exceeding a predetermined value and only the first display area being displayed on the display screen, controlling the second display area to be additionally displayed on the display screen, and
in response to the driving time exceeding the predetermined value and both the first display area and the second display area being displayed on the display screen, increasing the scale of the second display area according to a predetermined value.

20. The control method of claim 14, wherein the controlling comprises:
in response to a speed of a nearby vehicle exceeding a predetermined value, controlling only the first display area to be displayed on the display screen, and
in response to the speed of the nearby vehicle being less than the predetermined value, controlling both the first display area and the second display area to be displayed on the display screen.
